(19) United States
(12) Patent Application Publication
(10) Pub. No.: US 2026/0073833 A1
(43) Pub. Date: Mar. 12, 2026

(54) DRIVING METHOD AND APPARATUS FOR DISPLAY PANEL, STORAGE MEDIUM, AND DISPLAY DEVICE

(71) Applicant: Xiamen Tianma Display Technology Co., Ltd., Xiamen (CN)

(72) Inventors: Yu Zheng, Xiamen (CN); Ying Sun, Xiamen (CN); Lingfeng Zhou, Xiamen (CN); Weixing Liu, Xiamen (CN)

(73) Assignee: Xiamen Tianma Display Technology Co., Ltd., Xiamen (CN)

(21) Appl. No.: 19/386,599

(22) Filed: Nov. 12, 2025

(30) Foreign Application Priority Data
Feb. 13, 2025 (CN) 202510161608.0

(51) Int. Cl. G09G 3/20

(52) U.S. Cl. CPC G09G 3/2092; G09G 3/2007; G09G 2310/0286; G09G 2310/08; G09G 2320/0233; G09G 2320/06; G09G 2320/10; G09G 2330/021; G09G 2340/0435

(57) ABSTRACT

A driving method for a display panel includes when the current driving mode of the display panel is a multi-frequency driving mode, determining the refresh rate of each pixel in the display panel in the current driving mode, where the display panel in the multi-frequency driving mode includes at least a first display area and a second display area, and the refresh rate of a pixel in the first display area is different from the refresh rate of a pixel in the second display area; and during at least part of a display period in the current driving mode, controlling a data driving circuit to provide data signals with different driving strengths for the pixel in the first display area and the pixel in the second display area.

### CROSS-REFERENCE TO RELATED APPLICATION

This application claims priority to Chinese Patent Application No. 202510161608.0 filed Feb. 13, 2025, the disclosure of which is incorporated herein by reference in its entirety.

### TECHNICAL FIELD

The present disclosure relates to the field of display technology, particularly a driving method and apparatus for a display panel, a storage medium, and a display device.

### BACKGROUND

With the increasing use of display panels in various aspects of daily life, people's demands for display quality have become higher and higher. How to reduce power consumption while ensuring a high display quality of a display panel has become a pressing technical problem to be addressed.

### SUMMARY

The present disclosure provides a driving method and apparatus for a display panel, a storage medium, and a display device to reduce the power consumption of the display panel while ensuring a high display quality of the display panel.

In a first aspect, the present disclosure provides a driving method for a display panel.

The driving method for the display panel includes when the current driving mode of the display panel is a multi-frequency driving mode, determining the refresh rate of each pixel in the display panel in the current driving mode, where the display panel in the current driving mode includes at least a first display area and a second display area, and the refresh rate of a pixel in the first display area is different from the refresh rate of a pixel in the second display area; and during at least part of a display period in the current driving mode, controlling a data driving circuit to provide data signals with different driving strengths for the pixel in the first display area and the pixel in the second display area.

In a second aspect, embodiments of the present application provide a driving apparatus for a display panel. The driving apparatus for the display panel includes a display subarea determination module and a data signal providing module.

The display subarea determination module is configured to, when the current driving mode of the display panel is a multi-frequency driving mode, determine the refresh rate of each pixel in the display panel in the current driving mode, where the display panel in the current driving mode includes at least a first display area and a second display area, and the refresh rate of a pixel in the first display area is different from the refresh rate of a pixel in the second display area.

The data signal providing module is configured to, during at least part of a display period in the current driving mode, control a data driving circuit to provide data signals with different driving strengths for the pixel in the first display area and the pixel in the second display area.

In a third aspect, the present disclosure provides a display device. The display device includes a display panel and a driver chip.

The display panel includes multiple pixels arranged in an array.

The driver chip is configured to drive the display panel to display an image and perform the above driving method for the display panel.

In a fourth aspect, the present disclosure provides a computer-readable storage medium storing a computer instruction which, when executed by a processor, causes the processor to perform the above driving method for the display panel.

### BRIEF DESCRIPTION OF DRAWINGS

FIG. 1 is a diagram illustrating the structure of a display panel according to embodiments of the present disclosure.

FIG. 2 is a flowchart of a driving method for a display panel according to embodiments of the present disclosure.

FIG. 3 is a diagram illustrating the structure of a display panel according to embodiments of the present disclosure.

FIG. 4 is a diagram illustrating the structure of a display panel according to embodiments of the present disclosure.

FIG. 5 is a diagram illustrating the structure of a display panel according to embodiments of the present disclosure.

FIG. 6 is a diagram illustrating the structure of a gate driving circuit according to embodiments of the present disclosure.

FIG. 7 is a diagram illustrating the structure of a display panel according to embodiments of the present disclosure.

FIG. 8 is a diagram illustrating the structure of a display panel according to embodiments of the present disclosure.

FIG. 9 is a driving timing diagram of a display panel according to embodiments of the present disclosure.

FIG. 10 is a driving timing diagram of a display panel according to embodiments of the present disclosure.

FIG. 11 is a driving timing diagram of a display panel according to embodiments of the present disclosure.

FIG. 12 is a diagram illustrating the structure of a driving apparatus for a display panel according to embodiments of the present disclosure.

FIG. 13 is a diagram illustrating the structure of a display device according to embodiments of the present disclosure.

### DETAILED DESCRIPTION

To make the objects, technical solutions, and advantages of the present disclosure clearer, technical solutions of the present disclosure will be described completely below in conjunction with the drawings in embodiments of the present disclosure and specific implementations. Apparently, the embodiments described below are part, not all, of embodiments of the present disclosure. It is apparent for those skilled in the art that various modifications and variations may be made in the present disclosure without departing from the spirit or scope of the present disclosure. Therefore, the present disclosure is intended to cover modifications and variations of the present disclosure that fall within the scope of the corresponding claims (the claimed technical solutions) and equivalents thereof.

Moreover, the terms “first”, “second”, and the like in the present disclosure are used for distinguishing between different components but not used for describing any order, quantity, or significance. Similarly, the term “one”, “a”, “the”, or the like does not mean a quantitative limit, but indicates the existence of at least one. The term such as “including” or “comprising” means that elements or objects in front of the term cover elements or objects and their equivalents listed in the back of the term, but does not exclude other elements or objects. The term “connect”, “connected to”, or the like is not limited to a physical or mechanical connection, but may include an electrical connection, whether it is direct or indirect. “On”, “below”, “left”, “right”, and the like are utilized to indicate the relative positional relationship, and when the absolute position of the described object is changed, the relative positional relationship may also change accordingly. In addition, the description of being the same and equal involved in embodiments of the present disclosure does not indicate that two objects are completely equal in size and the same in shape. The two objects are allowed to be approximately the same or approximately equal within a certain error range.

It is to be noted that if not in collision, embodiments of the present disclosure may be combined with each other.

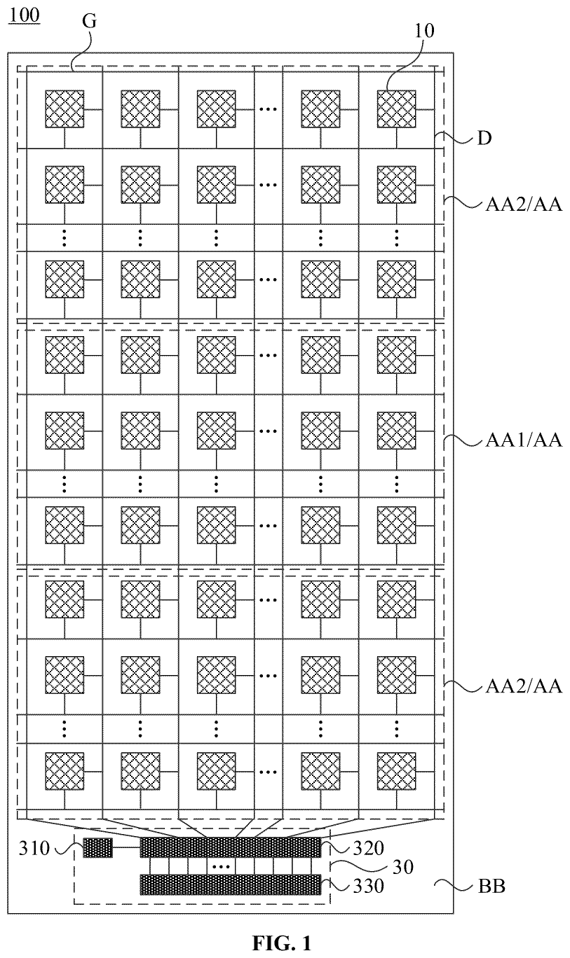

FIG. 1 is a diagram illustrating the structure of a display panel according to embodiments of the present disclosure. As shown in FIG. 1, the display panel 100 includes multiple pixels 10 arranged in an array. Data signals are provided for the pixels 10 in a one-to-one manner so that the pixels 10 can emit light for display according to the data signals so that the display panel 100 can present a corresponding image.

It is to be understood that the display panel 100 may be a self-luminous display panel or a non-self-luminous display panel. The type of the display panel 100 is not limited in embodiments of the present disclosure. When the display panel 100 is a self-luminous display panel, each pixel 10 of the display panel 100 may include a pixel circuit and a light-emitting element. The pixel circuit can control the luminance of the light-emitting element according to a received data signal, thereby enabling the display panel 100 to present a corresponding display image. When the display panel 100 is a non-self-luminous display panel, pixels 10 in the display panel 100 can emit light for display by reflecting or transmitting light from an external light source. For example, when the display panel 100 is a liquid-crystal display panel, each pixel 10 of the display panel 100 may include a pixel electrode, a common electrode, and a liquid crystal layer. The pixel electrode and the common electrode may generate a corresponding electric field according to a received data signal and a received common voltage signal. This electric field can control liquid crystal molecules in the liquid crystal layer to twist to adjust the transmittance of light provided by a backlight module. In this manner, the pixels 10 emit light for display, thereby allowing the display panel 100 to present a corresponding display image. For ease of description, unless otherwise specified, solutions in embodiments of the present disclosure are illustrated using an example in which the display panel is a self-luminous display panel.

With continued reference to FIG. 1, the display panel 100 also includes multiple data lines D and multiple gate lines G. The data lines D extend along the column direction. The gate lines G extend along the row direction. The data lines D and the gate lines G intersect to define the pixels 10. At least part of the pixels 10 located in the same column may be connected to the same data line D. At least part of the pixels 10 located in the same row may be connected to the same gate line G. The gate driving signals transmitted through the gate lines G can scan the pixels 10 row by row so that the data lines D can write data signals to the pixels 10 row by row in a time-division manner.

The display panel 100 also includes a display area AA and a non-display area BB. The non-display area BB at least partially surrounds the display area AA. The non-display area BB may be provided with a driver chip 30. The driver chip 30 may include a data driving circuit 320 and a driving strength adjustment circuit 310. The driving strength adjustment circuit 310 is electrically connected to the data driving circuit 320. The data driving circuit 320 may be electrically connected to each data line D. The data driving circuit 320 may provide a data signal to each data line D. The driving strength adjustment circuit 310 may adjust the driving strength of the data signal provided for each data line D by the data driving circuit 320. The driving strength of the data signal provided by the data driving circuit 320 may be understood as the output power used when the data driving circuit 320 outputs the data signal. The greater the driving strength of the data signal provided by the data driving circuit 320, the greater the output power of the data driving circuit 320, the stronger the charging capability of the data driving circuit 320 in charging the data line D, and the faster the data signal on the data line D can be written into the pixel 10. However, since higher power results in higher power consumption, when the output power of the data driving circuit 320 increases, the power consumption of both the data driving circuit 320 and the display panel 100 also increases. On the contrary, the smaller the driving strength of the data signal provided by the data driving circuit 320, the smaller the output power of the data driving circuit 320, and the smaller the power consumption of the display panel 100.

In addition, when the display panel 100 displays an image, the time interval in writing the data signal to the pixel 10 is controlled according to the display requirements. The number of times of the data signal is written to the pixel 10 per unit time is the refresh rate of the pixel 10. The driving mode of the display panel 100 may include a single-frequency driving mode and a multi-frequency driving mode. In the single-frequency driving mode, the refresh rates of the pixels 10 in the display area AA of the display panel 100 are the same. In the multi-frequency driving mode, the display area AA of the display panel may include multiple display areas. Pixels 10 in different display areas may have different refresh rates.

In the existing art, when the current driving mode of the display panel 100 is a multi-frequency driving mode, the data driving circuit 320 provides data signals for the pixels 10 in different rows in a time-division manner. The gate driving signals supplied to the gate lines G connected to pixels 10 in different display areas are controlled so that data signals output by the data driving circuit 320 can be written into pixels 10 when the pixels 10 receive gate driving signals at effective levels and cannot be written into the pixels 10 when the pixels 10 receive gate driving signals at ineffective levels. Accordingly, by adjusting the interval between effective levels of the gate driving signals provided for the pixels 10 in different display areas, it is possible to control the refresh rates of the pixels 10 in different display areas. This allows the display panel 100 to include a display area with a higher refresh rate and a display area with a lower refresh rate.

However, in the existing art, by adjusting the interval between effective levels of the gate driving signals provided for the pixels, it is possible to control the refresh rates of the pixels 10 in different display areas. In contrast, the driving strength adjustment circuit 310 maintains a fixed driving strength for the data signals output by the data driving circuit 320 to the data lines D, meaning that the same driving strength is applied to data signals provided for display areas with different refresh rates. As a result, the system fails to meet the different driving strength requirements of display areas with varying refresh rates. If data signals provided for the data lines D have a relatively low driving strength, pixels 10 in a high-refresh-rate area may not be charged quickly enough, thereby degrading the display effect of the display panel 100. If data signals provided for the data lines D have a relatively high driving strength, waste of driving strength occurs during a period in which data signals are not required in a low-refresh-rate area, not facilitating low power consumption in both the driver chip 30 and the display panel 100.

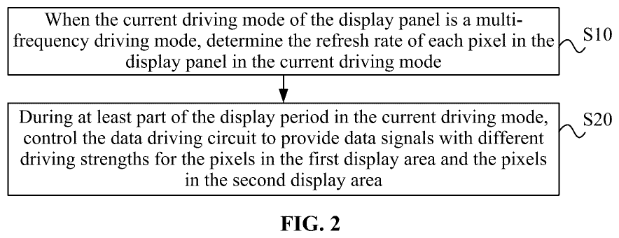

To solve the preceding technical problem, embodiments of the present disclosure provide a driving method for a display panel. The driving method for the display panel according to this embodiment of the present disclosure can reduce the power consumption of the display panel and improve the display quality of the display panel. The driving method for the display panel according to this embodiment of the present disclosure can control the display panel according to any embodiment of the present disclosure to display an image. The driving method for the display panel according to this embodiment of the present disclosure can be performed by a driving apparatus for a display panel according to any embodiment of the present disclosure. The driving apparatus for the display panel can be implemented by software and/or hardware. The driving apparatus for the display panel can be integrated in a driver chip for driving the display panel. FIG. 2 is a flowchart of a driving method for a display panel according to embodiments of the present disclosure. See FIG. 1 and FIG. 2.

In S10, when the current driving mode of the display panel is a multi-frequency driving mode, the refresh rate of each pixel in the display panel in the current driving mode is determined.

It can be understood that the driving mode of the display panel 100 may include a single-frequency driving mode and a multi-frequency driving mode. When different pixels 10 in the display panel 100 have different refresh rates, it can be determined that the current driving mode of the display panel 100 is the multi-frequency driving mode. The display panel 100 in the multi-frequency driving mode may include multiple display areas with different refresh rates. By way of example, when the current display image of the display panel 100 includes a static image and a dynamic image, the current driving mode of the display panel 100 may be set as the multi-frequency driving mode. At this time, the dynamic image may be displayed by a display area with a higher refresh rate, and the static image may be displayed by a display area with a lower refresh rate. This ensures the display effect of the dynamic image and reduces the number of times data signals are provided for pixels in the display area of the static image per unit time, thereby facilitating the low power consumption of the display panel.

It can also be understood that the driving period for the pixel 10 with a higher refresh rate includes at least a data write frame, and the driving period for the pixel 10 with a lower refresh rate includes at least a data write frame and at least one holding frame. When the time period for providing the data signal to the pixel 10 is the data write phase of the pixel 10, the data write frame may include the data write phase, and the holding frame does not include the data write phase, so that the data signal in the pixel 10 remains unchanged in the holding frame, thereby reducing the power consumption waste caused by writing the data signal.

When image display is performed at the maximum refresh rate f₀ across all display areas of the display panel 100, the driving period of each pixel 10 in the display panel 100 may include only a data write frame, that is, the duration of the data write frame may be equal to 1/f₀. When image display is performed at a refresh rate f₀₀ across all display areas, where f₀₀ is less than or equal to f₀, the driving period of each pixel 10 in the display panel 100 may include a data write frame and at least one holding frame, and the duration of the data write frame and the duration of the holding frame may each be equal to 1/f₀.

Specifically, since the number of times of providing the data signal to the display area with a higher refresh rate per unit time is greater than the number of times of providing the data signal to the display area with a lower refresh rate, pixels 10 in the display area with a lower refresh rate are in the holding frame during some of the data write frames of pixels 10 in the display area with a higher refresh rate. When it is determined that the current driving mode of the display panel 100 is the multi-frequency driving mode, the refresh rate of each pixel 10 in the display panel 100 in the current driving mode is determined, and display areas with different refresh rates are classified according to the refresh rate of each pixel 10 in the current driving mode. For example, an area where pixels 10 with higher refresh rates are located in the display panel 100 are classified as a first display area AA1, and an area where pixels 10 with lower refresh rates are located in the display panel 100 are classified as a second display area AA2. In this manner, an image with a higher refresh rate requirement is displayed in the first display area AA1, and an image without a higher refresh rate requirement is displayed in the second display area AA2, thereby reducing the display power consumption of the display panel while improving the display effect of the display panel.

In this embodiment, by way of example, the refresh rate of the pixels 10 in the first display area AA1 is greater than the refresh rate of the pixels 10 in the second display area AA2. In other embodiments, the refresh rate of the pixels 10 in the first display area AA1 may also be less than the refresh rate of the pixels 10 in the second display area AA2. This can be set by those skilled in the art according to requirements.

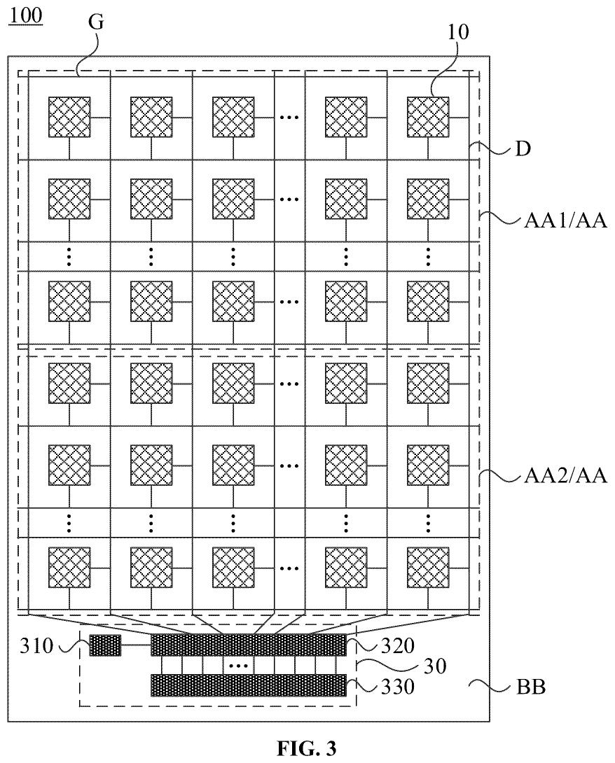

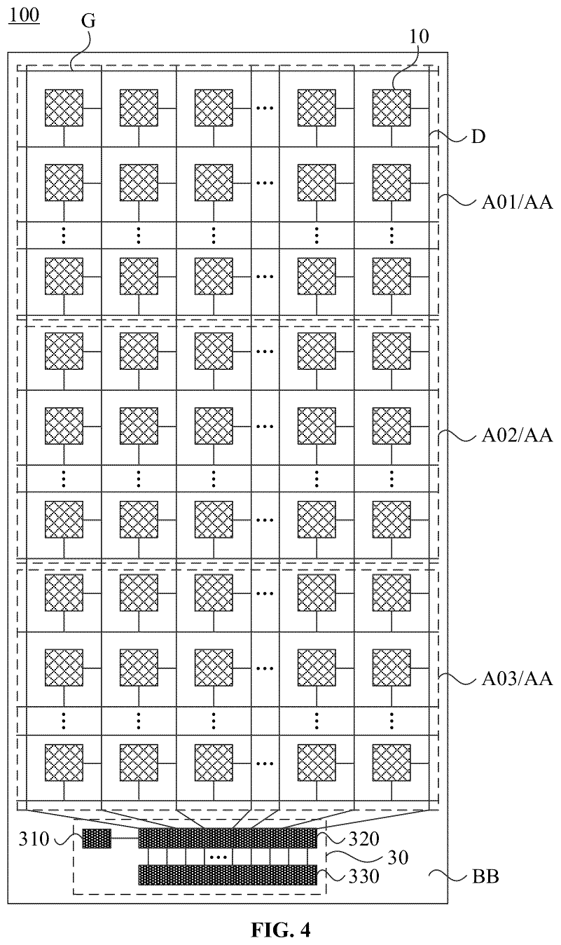

This embodiment illustratively describes a case where the pixels 10 in the display panel 100 operate at two different refresh rates, but the present disclosure is not limited thereto. When the pixels 10 in the display panel 100 operate at more than two different refresh rates, with respect to any two display areas in the display panel 100, the first display area AA1 may refer to a display area with a relatively higher refresh rate, and the second display area AA2 may refer to a display area with a relatively lower refresh rate. In addition, in this embodiment of the present disclosure, the display areas are divided based on differences in refresh rates, and no limitation is imposed on the number or positions of the different display areas. In an embodiment, as shown in FIG. 1, the display panel 100 includes one first display area AA1 and two second display areas AA2, and the first display area AA1 is located between the two second display areas AA2 along the column direction of the pixels 10. In another embodiment, as shown in FIG. 3, the display panel 100 includes one first display area AA1 and one second display area AA2 arranged along the column direction of the pixels 10. In other embodiments, as shown in FIG. 4, the display panel 100 may include three display areas A01, A02 and A03 having different refresh rates. When the refresh rate of the pixels 10 in the display area A01 is greater than the refresh rate of the pixels 10 in the display area A02, of these two display areas, the display area A01 may be the first display area, and the display area A02 may be the second display area. When the refresh rate of the pixels 10 in the display area A02 is greater than the refresh rate of the pixels 10 in the display area A03, of these two display areas, the display area A02 may be the first display area, and the display area A03 may be the second display area. Similarly, when the refresh rate of the pixels 10 in the display area A01 is greater than the refresh rate of the pixels 10 in the display area A03, of these two display areas, the display area A01 may be the first display area, and the display area A03 may be the second display area. In this embodiment of the present disclosure, the positions and number of the first and second display areas may be set by those skilled in the art according to requirements.

In addition, in this embodiment of the present disclosure, display areas with different refresh rates may be arranged in the row and/or column direction of the pixels 10. This arrangement may be designed according to requirements and is not limited in the present disclosure. For ease of description, this embodiment of the present disclosure illustratively describes the technical solution using an example in which display areas with different refresh rates are arranged in the column direction of the pixels 10, and the display panel 100 includes two display areas with different refresh rates.

In S20, during at least part of the display period in the current driving mode, the data driving circuit is controlled to provide data signals with different driving strengths for the pixels in the first display area and the pixels in the second display area.

As shown in FIG. 3, at least part of the display period in the current driving mode may be a time period in which the pixels 10 in the first display area AA1 and the pixels 10 in the second display area AA2 are both in the data write frame or may be a time period in which the pixels 10 in the display area with a higher refresh rate is in the data write frame while the pixels 10 in the display area with a lower refresh rate is in the holding frame.

It can be understood that the driver chip 30 periodically acquires grayscale data from the system mainboard. The grayscale data acquired by the driver chip 30 is parsed into the data signals of the pixels 10 so that in the data write phase of the pixels 10, the data driving circuit 320 can correspondingly output the data signals of the pixels 10 and write the data signals into the pixels 10 in a one-to-one manner. The number of times the driver chip 30 acquires the grayscale data from the system mainboard per unit time may be the same as the basic refresh rate of the display panel 100, that is, may be the same as the minimum value of the refresh rates of the display areas in the display panel 100. The basic refresh rate may be less than or equal to the maximum refresh rate of the display panel 100 for image display. In this manner, when all pixels 10 in the display panel 100 are in the data write frame, the driver chip 30 acquires the grayscale data from the system mainboard. The grayscale data, after being parsed, includes data signals in one-to-one correspondence with the pixels 10 in the display panel 100. The driver chip 30 may control whether to write the data signals into the pixels 10 according to actual requirements. Regardless of whether to write the data signals into the pixels 10, the data driving circuit 320 may sequentially output the data signals for each row of pixels 10.

In addition, the driver chip 30 may also be provided with a data register 330. The data signals for each row of pixels 10 may be sequentially stored in the data register 330. When the data driving circuit 320 is required to output the data signal corresponding to the nth row of pixels 10, the data register 330 can provide the data signal of the nth row of pixels 10 stored therein for the data driving circuit 320. Meanwhile, the data signals of the (n+1)th row of pixels 10 can be stored in the data register 330. That is, after the data signal of the previous row of pixels 10 is provided for the data driving circuit 320, the data register 330 can store the data signal of the next row of pixels 10. In this manner, the driving strength adjustment circuit 310 can adjust, according to the control requirements of each row of pixels 10, the magnitude of the driving strength of the data signal provided for each row of pixels 10 by the data driving circuit 320. n is a positive integer.

By way of example, when the ith row of pixels 10 is located in the display area with a higher refresh rate, the jth row of pixels 10 is located in the display area with a lower refresh rate, and the data write frame of the ith row of pixels 10 and the holding frame of the jth row of pixels 10 are used in the current time period, in the data write frame of the ith row of pixels 10, a faster charging speed is required in providing data signals for the ith row of pixels 10, so that enough data signals can be written into the ith row of pixels 10 in the data signal writing phase of the ith row of pixels 10 to ensure the display and light emission accuracy of the ith row of pixels 10. At this time, the driving strength adjustment circuit 310 can control the data driving circuit 320 to output the data signals of the ith row of pixels 10 with a larger driving strength, thereby ensuring that the ith row of pixels 10 can be quickly charged and thus ensuring the display effect of the display area with a higher refresh rate. In the holding frame of the jth row of pixels 10, there is no need to write the data signals into the jth row of pixels, so there is no need to write the data signals faster. At this time, the driving strength adjustment circuit 310 can control the data driving circuit 320 to provide the data signals with a smaller driving strength for the jth row of pixels 10, thereby reducing the power consumption of the data driving circuit 320 in this time period and reducing the power consumption of the pixels 10 in the display area with a lower refresh rate in the display panel 100.

It is to be understood that this embodiment illustratively describes a case where a display area with a lower refresh rate is provided with a data signal having a lower driving strength. This is not intended to limit the present disclosure. In other embodiments, since the data signals are written in the display area with a lower refresh rate only after a long time interval, there may be signal leakage and loss within this time interval, resulting in a lower potential in the pixels 10. To write the data signals quickly in the data write frame of the pixels 10 in the display area with a lower refresh rate, at this time, the driving strength adjustment circuit 310 may control the data driving circuit 320 to provide the data signals with a larger driving strength for the pixels 10 in the display area with a lower refresh rate. This allows the data write conditions of the display area with a higher refresh rate and the display area with a lower refresh rate to remain consistent, thereby improving the display uniformity of the display panel.

In summary, when the current driving mode of the display panel is the multi-frequency driving mode, the refresh rate of each pixel in the display panel in the current driving mode is determined so that the pixels 10 in different display areas can be controlled to be written with data signals with different refresh rates according to the display requirements of the display panel, thereby reducing the power consumption of the display panel 100 while ensuring that the display panel 100 has a high display effect. During at least part of the display period in the current driving mode, according to the high and low conditions of the refresh rates of the pixels 10 in different display areas, the data driving circuit 320 is adjusted by the driving strength adjustment circuit 310 to provide data signals with different driving strengths for the pixels 10 in the display areas with different refresh rates, so that the pixels 10 in the display areas with different refresh rates can be written with data signals through different driving strengths. This prevents pixels with different refresh rates in different display areas from being written with data signals with the same driving strength, which would otherwise result in high power consumption and affect the improvement of the display quality, thereby reducing the power consumption of the display panel and improving the display quality of the display panel.

In an optional embodiment, with continued reference to FIG. 3, controlling the data driving circuit 320 to provide the data signals with different driving strengths for the pixels 10 in the first display area AA1 and the pixels 10 in the second display area AA2 includes providing data signals with a first preset driving strength for the pixels 10 in the first display area AA1 and providing data signals with a second preset driving strength for the pixels 10 in the second display area AA2. The refresh rate of the pixels 10 in the first display area AA1 is greater than the refresh rate of the pixels 10 in the second display area AA2, and the second preset driving strength is less than the first preset driving strength.

The refresh rate of the pixels 10 in the first display area AA1 is greater than the refresh rate of the pixels 10 in the second display area AA2 so that the first display area AA1 can be a display area with a higher refresh rate while the second display area AA2 can be a display area with a lower refresh rate. When the data signals with different driving strengths are provided for the pixels 10 in the first display area AA1 and the pixels 10 in the second display area AA2 in the data write frame of the pixels 10 in the first display area AA1 and the holding frame of the pixels 10 in the second display area AA2, in the data write frame of the pixels 10 in the second display area AA2, it is required to provide data signals for the pixels 10 in the second display area AA2 at a faster charging speed. Then the driving strength adjustment circuit 310 adjusts the magnitude of the driving strength of the data signals provided by the data driving circuit 320 according to the refresh rate of the pixels 10 in the first display area AA1, so that the data driving circuit 320 provides the data signals with a larger driving strength for each row of pixels 10 in the first display area AA1, that is, data signals with the first preset driving strength, thereby ensuring that data signals can be quickly written into the pixels 10 in the first display area AA1 and ensuring the display effect of the first display area AA1 with a higher refresh rate. In addition, in the holding frame of the pixels 10 in the second display area AA2, there is no need to write data signals into the pixels 10 in the second display area AA2. That is, the pixels 10 in the second display area AA2 do not need to be quickly written with data signals. At this time, the driving strength adjustment circuit 310 may adjust, according to the refresh rate of the pixels 10 in the second display area AA2, the magnitude of the driving strength of the data signals provided by the data driving circuit 320, so that the data driving circuit 320 provides data signals with a smaller driving strength, that is, data signals with the second preset driving strength, for each row of pixels 10 in the second display area AA2, thereby enabling the data driving circuit 320 to have a lower output power, reducing the power consumption of the data driving circuit 320, and reducing the power consumption of the display panel.

It is to be noted that this embodiment of the present disclosure does not limit the values of the first preset driving strength and the second preset driving strength as long as the first preset driving strength is greater than the second preset driving strength. This can be set by those skilled in the art according to requirements.

In an optional embodiment, the driving strength value of the second preset driving strength is 0.

With continued reference to FIG. 3, the driving strength adjustment circuit 310 can adjust the magnitude of the driving strength of the data signal provided by the data driving circuit 320. Different driving strength value ranges may correspond to different driving strength levels. The lower the driving strength level, the smaller the driving strength value, the lower the output power of the data signal provided by the data driving circuit 320, and the lower the power consumption of the data driving circuit 320. When the driving strength adjustment circuit 310 adjusts the driving strength of the data signal provided by the data driving circuit 320 to the driving strength of the lowest driving strength level, the driving strength value of the data signal provided by the data driving circuit 320 may be 0, and the power consumption of the data driving circuit 320 is the smallest. As the driving strength level increases, the greater the driving strength value of the data signal provided by the data driving circuit 320, the greater the power consumption of the data driving circuit 320.

Specifically, since the pixels 10 in the first display area AA1 have a higher refresh rate, and the pixels 10 in the second display area AA2 have a lower refresh rate, when the pixels 10 in the first display area AA1 are in the data write frame and the pixels 10 in the second display area AA2 are in the holding frame, there is no need to write data signals into the pixels 10 in the second display area AA2, so there is no need to write the data signals faster. At this time, the data driving circuit 320 is adjusted by the driving strength adjustment circuit 310 to provide data signals with a driving strength value of 0 for each row of pixels 10 in the second display area AA2 so that the power consumption of the data driving circuit 320 and the display panel 100 can be reduced to the greatest extent.

It is to be understood that since data signals output by the data driving circuit 320 do not need to be written into the pixels 10 in the holding frame of the pixels 10, in the holding frame of the pixels 10, when the data driving circuit 320 needs to provide data signals for the pixels 10, data signals output by the data driving circuit 320 may be data signals corresponding to the pixels 10 or other data signals; and in the data write frame of the pixels 10, data signals output by the data driving circuit 320 need to be written into the pixels 10 so that in the data write phase of the data write frame of the pixels 10, the data driving circuit 320 needs to provide the data signals corresponding to the pixels 10. This is not limited in this embodiment of the present disclosure, provided that the display effect of the display panel is not adversely affected.

In an optional embodiment, with continued reference to FIG. 3, the data signal provided for the pixel 10 in the first display area AA1 is a data signal corresponding to the grayscale of the pixel 10 in the first display area AA1 in the current display frame; and the data signal provided for the pixel 10 in the second display area AA2 is a set data signal.

Specifically, when the pixels 10 in the first display area AA1 are in the data write frame and the pixels 10 in the second display area AA2 are in the holding frame, the driver chip 30 acquires the grayscale data of the current image in the display panel 100 from the system mainboard and determines the data signals corresponding to each row of pixels 10 after parsing the grayscale data. In an example in which the display panel 100 includes n rows of pixels, the first row of pixels 10 to the ith row of pixels 10 are located in the first display area AA1, and the (i+1)th row of pixels 10 to the nth row of pixels 10 are located in the second display area AA2, the data driving circuit 320 sequentially acquires the data signals of the first row of pixels 10 to the ith row of pixels 10 from the data register 330 and outputs the data signals of these rows of pixels 10 with a first preset driving strength in the data write phase of the first row of pixels 10 to the ith row of pixels 10 so that the first row of pixels 10 to the ith row of pixels 10 can be written with data signals in a one-to-one manner, thereby ensuring the display and light emission accuracy of the pixels 10 in the first display area AA1. After the data signals of the first row of pixels 10 to the ith row of pixels 10 are written, that is, after the data write phase of the ith row of pixels 10, the data driving circuit 320 may stop acquiring the data signals of the (i+1)th row of pixels 10 to the nth row of pixels 10 from the data register 330 and may adjust the data signals of the output end thereof to the set data signals and output the set data signals with the second preset driving strength until entering the data write phase of the first row of pixels 10 again. Upon entering the data write phase of the first row of pixels 10 again, the data driving circuit 320 acquires the data signals of the first row of pixels 10 from the data register 330 again and writes these data signals to the first row of pixels 10 in a one-to-one manner. In this manner, in the time period after the data write phase of the ith row of pixels 10 and before the data write phase of the first row of pixels 10 is entered again, the data driving circuit 320 may continuously output the set data signals so that the data signals output by the output terminals of the data driving circuit 320 remain unchanged, thereby preventing the data driving circuit 320 from generating additional power consumption due to repeated signal jumps at the output terminals of the data driving circuit 320 and preventing the problem of corresponding power consumption due to repeated charging/discharging of the data lines D due to repeated signal jumps at the output terminals of the data driving circuit 320, thereby reducing the overall power consumption of the data driving circuit 320 and the display panel 100.

In an optional embodiment, with continued reference to FIG. 3, the set data signal is the last data signal provided for a pixel in the display panel 10 and corresponding to the grayscale of the pixel 10 before the data signal with the second preset driving strength is provided for the pixel 10 in the second display area AA2.

In an example in which the first row of pixels 10 to the ith row of pixels 10 are located in the first display area AA1 and the (i+1)th row of pixels 10 to the nth row of pixels 10 are located in the second display area AA2, the data driving circuit 320 sequentially outputs data signals of the first row of pixels 10 to the ith row of pixels 10 and writes the data signals into the pixels 10 in the first display area AA1 in a one-to-one manner. After the data write phase of the ith row of pixels 10 is completed, the data signals output by the output terminals of the data driving circuit 320 may be maintained as data signals in one-to-one correspondence with the pixels 10 in the ith row of pixels 10 until entering the data write phase of the first row of pixels 10 again. In this manner, in the time period after the data write phase of the ith row of pixels 10 and before the data write phase of the first row of pixels 10 is entered again, the data signals at the output terminals of the data driving circuit 320 remain unchanged so that it is unnecessary to repeatedly charge/discharge the output terminals of the data driving circuit 320 and the data lines D, thereby facilitating the low power consumption of the data driving circuit 320 and the display panel 100.

In another optional embodiment, the voltage of the set data signal is a fixed value.

By way of example, with continued reference to FIG. 3, in an example in which the first row of pixels 10 to the ith row of pixels 10 are located in the first display area AA1, the (i+1)th row of pixels 10 to the nth row of pixels 10 are located in the second display area AA2, and the first row of pixels 10 to the nth row of pixels 10 are sequentially arranged from the side away from the driver chip to the side facing the driver chip, after the data write phase of the ith row of pixels 10 is completed, the voltages of the data signals output by the output terminals of the data driving circuit 320 can all be adjusted to fixed values until entering the data write phase of the first row of pixels 10 again. In this manner, in the time period after the data write phase of the ith row of pixels 10 and before the data write phase of the first row of pixels 10 is entered again, the voltages of the data signals at the output terminals of the data driving circuit 320 remain fixed values so that it is unnecessary to repeatedly charge/discharge the output terminals of the data driving circuit 320 and the data lines D, thereby facilitating the low power consumption of the data driving circuit 320 and the display panel 100.

In addition, when the voltages of the data signals at the output terminals of the data driving circuit 320 are fixed values, if the data write phase of the first row of pixels 10 is entered again, the output terminals of the data driving circuit 320 can all output the data signals of the first row of pixels 10 on the basis of the fixed voltages so that the data lines D can be charged with the data signals of the first row of pixels 10 on the basis of the fixed voltages, thereby ensuring the writing accuracy of the first row of pixels 10 and improving the display quality of the display panel 100.

It is to be noted that the voltage of the fixed value is not limited in this embodiment of the present disclosure and can be set according to requirements. In an embodiment, the fixed value may be the voltage of the data signal corresponding to a grayscale of 0. In other embodiments, the fixed value may also be the signal of the maximum voltage that can be output by the driver chip.

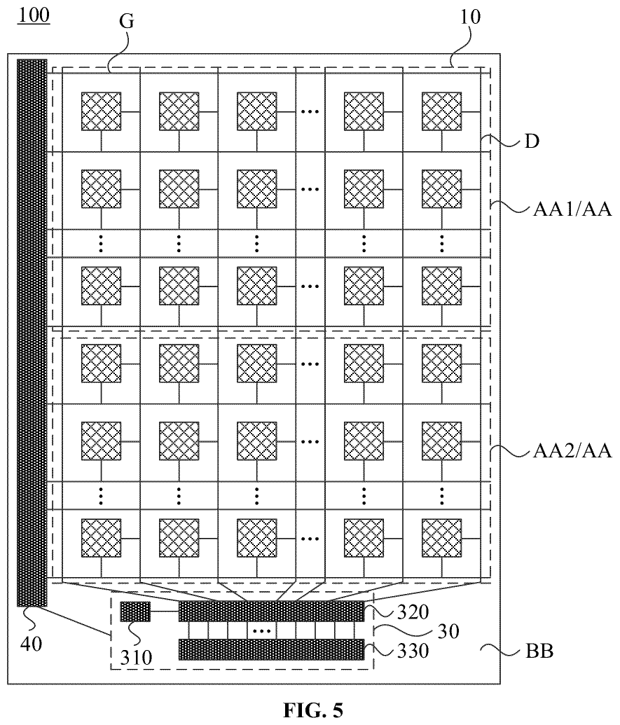

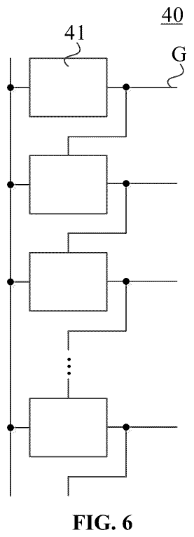

Optionally, on the basis of the preceding embodiments, FIG. 5 is a diagram illustrating the structure of a display panel according to embodiments of the present disclosure, and FIG. 6 is a diagram illustrating the structure of a gate driving circuit according to embodiments of the present disclosure. Referring to FIG. 5 and FIG. 6, the display panel 100 also includes a gate driving circuit 40, the gate driving circuit 40 provides a gate driving signal G for each row of pixels 10 in the display panel 100, and the driving method for the display panel 100 also includes during the display period of one frame of the display panel 100, providing a refresh control signal Ctrl for the gate driving circuit 40 to control the gate driving signal Gout provided for each row of pixels 10 in the display panel 100 by the gate driving circuit 40.

The gate driving circuit 40 may be located in the non-display area BB of the display panel 100, or in other feasible embodiments, the gate driving circuit 40 may also be located in the display area of the display panel 100 to reduce the size of the bezel of the display panel 100 to achieve a narrow bezel or even no bezel of the display panel 100.

Specifically, the gate drive circuit 40 may include multiple stages of shift register units 41 cascaded with each other. The multiple stages of shift register units 41 are electrically connected to the corresponding gate lines G so that the multiple stages of shift register units 41 can provide gate driving signals Gout to the corresponding gate lines G under the control of the refresh control signal Ctrl. During the time period in which the pixels 10 in the display panel 100 are all required to be written with data signals, the refresh control signal Ctrl may control the effective level time of the gate driving signal Gout provided by each stage of shift register unit 41 to shift sequentially to ensure that the data signals provided for all rows of pixels 10 by the data driving circuit 320 in a time-division manner can be written into the pixels 10 in a one-to-one manner. During the time period in which each pixel 10 in the display panel 100 is not required to be written with a data signal, that is, in a time period in which each pixel 10 in the display panel 100 is in a holding frame, the refresh control signal Ctrl may keep the gate driving signal Gout provided by each stage of shift register unit 41 at ineffective levels so that the data signals provided by the data driving circuit 320 cannot be written into the pixels 10. When the display panel 100 includes a first display area AA1 and a second display area AA2, during the time period in which the pixels 10 in the first display area AA1 require data signal writing while the pixels 10 in the second display area AA2 do not, the refresh control signal Ctrl controls the gate driving signals Gout output by the shift register units 41 electrically connected to the pixels 10 in the first display area AA1 to shift sequentially and keeps the gate driving signals Gout output by the shift register units 41 connected to the pixels 10 in the second display area AA2 at ineffective levels. In this manner, the data signals provided by the data driving circuit 320 can be written one-to-one into the respective pixels 10 in the first display area AA1 while being prevented from being written into the pixels 10 in the second display area AA2. In this manner, the refresh control signal Ctrl controls the gate driving signals Gout output by different stages of shift register units 41 in the gate driving circuit 40, allowing the pixels 10 that do not require data signal writing to receive gate driving signals Gout at ineffective levels. This reduces the power consumption caused by the charging and discharging of the gate lines G due to transitions in the gate driving signals Gout, thereby better lowering the overall power consumption of the display panel 100.

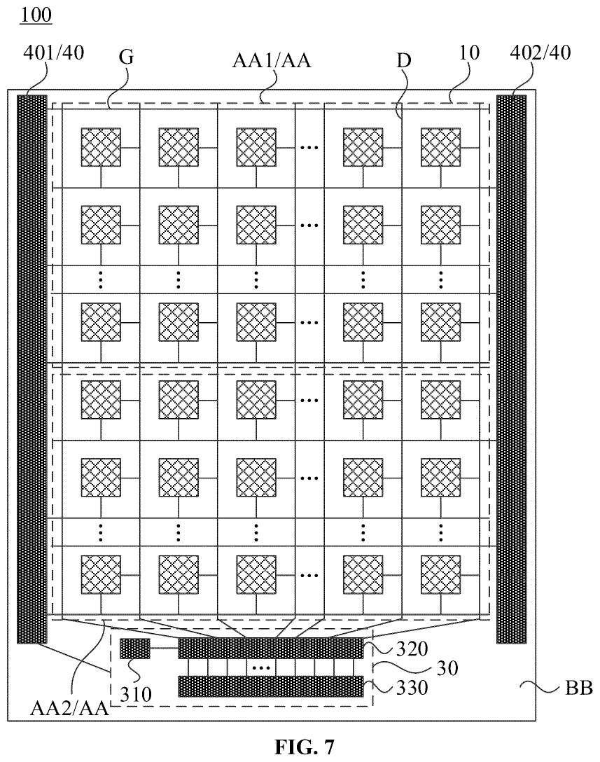

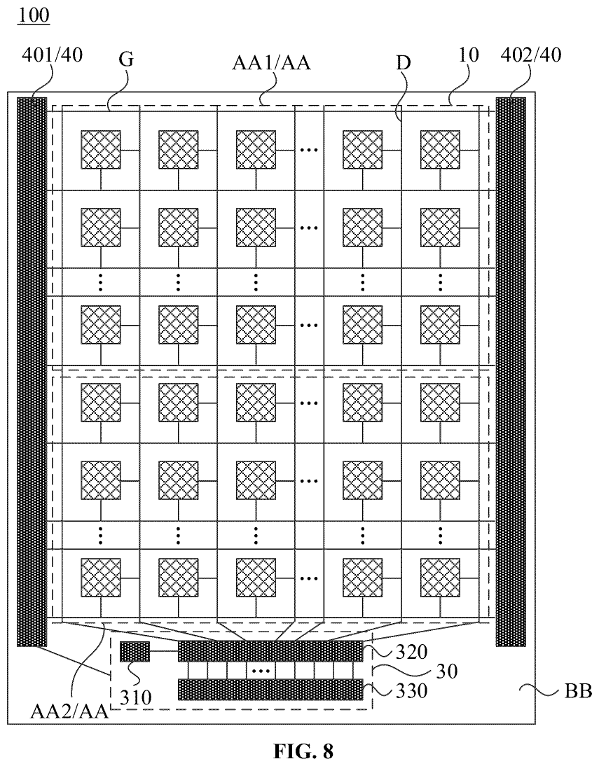

It is be noted that FIG. 5 illustrates the gate driving circuit 40 located in the non-display area BB on one side of the display area AA. However, in other embodiments of the present disclosure, as shown in FIG. 7, when the gate driving circuit 40 is located in the non-display area BB of the display panel 100, the gate driving circuit 40 of the display panel 100 may include a first gate driving circuit 401 and a second gate driving circuit 402 located on opposite sides of the display area AA. The first gate driving circuit 401 may provide gate driving signals Gout for pixels 10 in odd rows while the second gate driving circuit 402 may provide gate driving signals Gout for pixels 10 in even rows. Alternatively, as shown in FIG. 8, when the gate driving circuit 40 of the display panel 100 includes the first gate driving circuit 401 and the second gate driving circuit 402 located on opposite sides of the display area AA, for the same gate line G, the first gate driving circuit 401 may provide a gate driving signal Gout for this gate line G from the left side of the display area, and the second gate driving circuit 402 may provide a gate driving signal Gout for this gate line G from the right side of the display area. Provided that the refresh control signal Ctrl can be used to control the gate driving circuit 40 to provide gate driving signals Gout for different rows of pixels 10, the configuration of the gate driving circuit in the display panel 100 is not limited in this embodiment of the present disclosure. For ease of description, unless otherwise specified, solutions in embodiments of the present disclosure are illustrated using an example in which the gate driving circuit is disposed in the non-display area on one side of the display area.

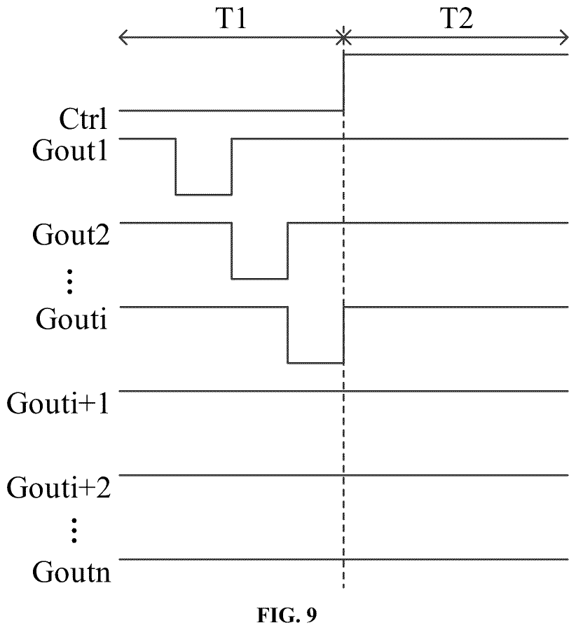

In an optional embodiment, FIG. 9 is a driving timing diagram of a display panel according to embodiments of the present disclosure. With reference to FIG. 5, FIG. 6, and FIG. 9, during the display period of one frame of the display panel 100, providing the refresh control signal Ctrl for the gate driving circuit 40 to control the gate driving signal Gout provided for each row of pixels 10 in the display panel 100 by the gate driving circuit 40 includes: when providing a data signal for each pixel 10 in the first display area AA1, providing an effective level of the refresh control signal Ctrl for the gate driving circuit 40 to control the gate driving circuit 40 to sequentially provide an effective level of the gate driving signal Gout for each row of pixels 10 in the first display area AA1; and when providing a data signal for each pixel 10 in the second display area AA2, providing an ineffective level of the refresh control signal Ctrl for the gate driving circuit 40 to control the gate driving circuit 40 to sequentially provide an ineffective level of the gate driving signal Gout for each row of pixels 10 in the second display area AA2.

The display period of one frame of the display panel 100 may be one driving period of the display panel 100. This driving period may be the least common multiple of the data signal refresh periods of the pixels 10 in the different display areas AA. Alternatively, the display period of one frame of the display panel 100 may be equal to the data signal refresh period of the pixels 10 in the display area AA having the highest refresh rate. This may be designed according to actual requirements and is not limited in this embodiment of the present disclosure. For ease of description, unless otherwise specified, solutions in embodiments of the present disclosure are illustrated using an example in which the display period of one frame of the display panel 100 is equal to the data signal refresh period of the pixels 10 in the display area AA having the highest refresh rate.

Specifically, when the display panel 100 includes different display areas AA with different refresh frequencies, during the display period of some frames of the display panel 100, some of the pixels 10 are in a data write frame while others are in a holding frame. During the time period in which the data driving circuit 320 provides data signals for the pixels 10 in the data write frame, it is required to control the gate driving circuit 40 to provide gate driving signals Gout at effective levels for these pixels 10. At this time, the driver chip 30 may provide an effective level of the refresh control signal Ctrl for the gate driving circuit 40 so that during the time period in which the gate driving circuit 40 receives the effective level of the refresh control signal Ctrl, the gate driving circuit 40 can sequentially provide gate driving signals Gout at effective levels for the corresponding gate lines G, allowing the data signals provided by the data driving circuit 320 to be written one-to-one into the pixels 10 electrically connected to these gate lines G. On the other hand, during the time period in which the data driving circuit 320 provides data signals for the pixels 10 in the holding frame, it is required to control the gate driving circuit 40 to provide gate driving signals Gout at ineffective levels to these pixels 10. At this time, the driver chip 30 may provide an ineffective level of the refresh control signal Ctrl for the gate driving circuit 40 so that during the time period in which the gate driving circuit 40 receives the ineffective level of the refresh control signal Ctrl, the gate driving signals Gout output by the gate driving circuit 40 remain at an ineffective level, thereby preventing the data signals provided by the data driving circuit 320 from being written into the pixels 10. In this manner, by controlling the timing of the effective and ineffective levels of the refresh control signal Ctrl provided for the gate driving circuit 40, it is possible to control the gate driving signals Gout output by the gate driving circuit 40, thereby reducing the overall power consumption of the display panel 100 while satisfying the data signal refresh requirements of the pixels 10 in the high-refresh-rate display areas AA.

By way of example, assume that the first to ith rows of pixels 10 are located in the first display area AA1, and the (i+1)th to nth rows of pixels 10 are located in the second display area AA2. When the pixels 10 in the first display area AA1 have a higher refresh rate and the pixels 10 in the second display area AA2 have a lower refresh rate, during the display period of some frames of the display panel 100, the driving period of the pixels 10 in the first display area AA1 includes a data write frame while the driving period of the pixels 10 in the second display area AA2 includes a holding frame. As a result, the refresh control signal Ctrl during that frame display period may include both effective and ineffective levels. When the data driving circuit 320 provides data signals for the different rows of pixels 10 in the first display area AA1, the driver chip 30 provides the refresh control signal Ctrl an effective level for the gate driving circuit 40 to control the gate driving circuit 40 to sequentially provide gate driving signals Gout (Gout1, Gout2, . . . , Gouti) at effective levels for the first to ith rows of pixels 10 located in the first display area AA1. At this time, the data signals provided by the data driving circuit 320 can be written one-to-one into the first to ith rows of pixels 10. On the other hand, when the data driving circuit 320 provides data signals for the different rows of pixels 10 in the second display area AA2, the driver chip 30 provides the refresh control signal Ctrl at an ineffective level for the gate driving circuit 40 to control the gate driving circuit 40 to provide gate driving signals Gout (Gouti+1, Gouti+2, . . . , Goutn) at ineffective levels for the (i+1)th to nth rows of pixels 10. At this time, the data signals provided by the data driving circuit 320 cannot be written into the pixels 10. In this manner, it is possible to better reduce the power consumption of the display panel 100 while ensuring that the pixels 10 in the first display area AA1 are refreshed with data signals while the pixels 10 in the second display area AA2 retain the data signals written during the previous driving period unchanged.

It is to be understood that FIG. 9 illustrates solutions in embodiments of the present disclosure by using an example in which the effective levels of the refresh control signal and the gate driving signal are low levels while the ineffective levels of the refresh control signal and the gate driving signal are high levels. However, in this embodiment of the present disclosure, the high or low levels of the effective and ineffective levels of the refresh control signal and the gate driving signal may be designed according to requirements. For example, when components in the gate driving circuit 40 that are controlled by the refresh control signal Ctrl include a P-type transistor, the effective level of the refresh control signal Ctrl is a low level while the ineffective level of the refresh control signal Ctrl is a high level; and when components in the gate driving circuit 40 that are controlled by the refresh control signal Ctrl include an N-type transistor, the effective level of the refresh control signal Ctrl is a high level while the ineffective level of the refresh control signal Ctrl is a low level. Similarly, when components in the pixel 10 that are controlled by the gate driving signal Gout include a P-type transistor, the effective level of the gate driving signal Gout is a low level while the ineffective level of the gate driving signal Gout is a high level; and when components in the pixel 10 that are controlled by the gate driving signal Gout include an N-type transistor, the effective level of the gate driving signal Gout is a high level while the ineffective level of the gate driving signal Gout is a low level. For ease of description, unless otherwise specified, solutions in embodiments of the present disclosure are illustrated using an example in which the effective level is a low level while the ineffective level is a high level.

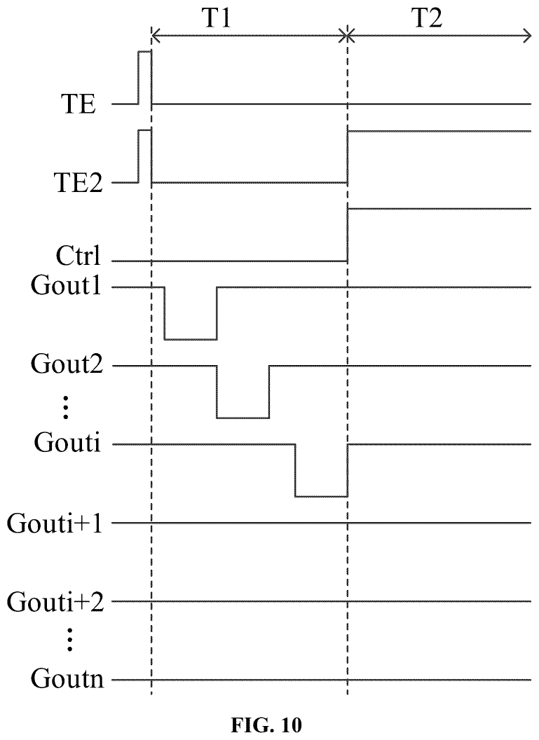

Optionally, on the basis of the preceding embodiments, FIG. 10 is a driving timing diagram of a display panel according to embodiments of the present disclosure. Referring to FIG. 5 and FIG. 10, the driving method of the display panel also includes acquiring grayscale data of the display panel 100 in real time, where the grayscale data includes the grayscale of each pixel 10 in the display panel 100; outputting a first data output control signal TE according to the time when the grayscale data is acquired; and outputting a second data output control signal TE2 according to the first data output control signal TE and the refresh control signal Ctrl. The driving strength of a data signal provided for each pixel 10 in the display panel is controlled according to the second data output control signal TE2.

It is to be understood that the grayscale of the pixel 10 may be the luminance level at which the pixel 10 emits light for display. Different grayscales correspond to different luminance levels. The higher the grayscale, the higher the luminance. By controlling the display luminance of pixels 10 of different colors, it is possible that the display panel 100 presents a richly colored display image.

It is also to be understood that the driver chip 30 may include at least two data output control signal ports, one of which can output a first data output control signal TE, and the other of which can output a second data output control signal TE2. Through these two data output control signal ports, the first data output control signal TE and the second data output control signal TE2 can be detected.

Specifically, the driver chip 30 may periodically acquire the grayscale data of the current display frame of the display panel 100 from the system mainboard and parse the grayscale data to obtain the data signal corresponding to each pixel 10. At this time, the driver chip 10 may generate the first data output control signal TE according to the period of acquiring the grayscale data so that the first data output control signal TE changes periodically according to the period of acquiring the grayscale data by the driver chip 10 so that the driver chip can output the periodically changing first data output control signal TE. The first data output control signal TE may control a grayscale parsing circuit in the driver chip 30 to parse the grayscale data. After obtaining the data signals of different pixels 10, the data signals of different rows of pixels 10 are sequentially written into the data registers 330 and then provided for the data driving circuit 320 by the data registers 330 so that the data driving circuit 320 can correspondingly output the data signals of different rows of pixels 10.

After the first data output control signal TE is generated by the driver IC 30, the second data output control signal TE2 may also be generated according to the first data output control signal TE and the refresh control signal Ctrl. The second data output control signal TE2 can control the driving strength level of the driving strength adjustment circuit 310, enabling the driving strength adjustment circuit 310 to control, according to this driving strength level, the driving strength of the data signals output by the data driving circuit 320. In this manner, when the data driving circuit 320 provides data signals for the pixels 10 in a data write frame, for example, during the time period T1, the second data output control signal TE2 may control the driving strength adjustment circuit 310 to operate at a first preset driving strength level so that the driving strength adjustment circuit 310 controls the data driving circuit 320 to provide data signals for different pixels 10 with a first preset driving strength; and when the data driving circuit 320 provides data signals for the pixels 10 in a holding frame, for example, during the time period T2, the second data output control signal TE2 may control the driving strength adjustment circuit 310 to operate at a second preset driving strength level so that the driving strength adjustment circuit 310 controls the data driving circuit 320 to provide data signals for different pixels 10 with a second preset driving strength. In this manner, by using the second data output control signal to control the driving strength adjustment circuit 310 to adjust the driving strength of the data signals provided by the data driving circuit 320, it is possible to reduce the power consumption of the display panel while enhancing the display effect of the display panel.

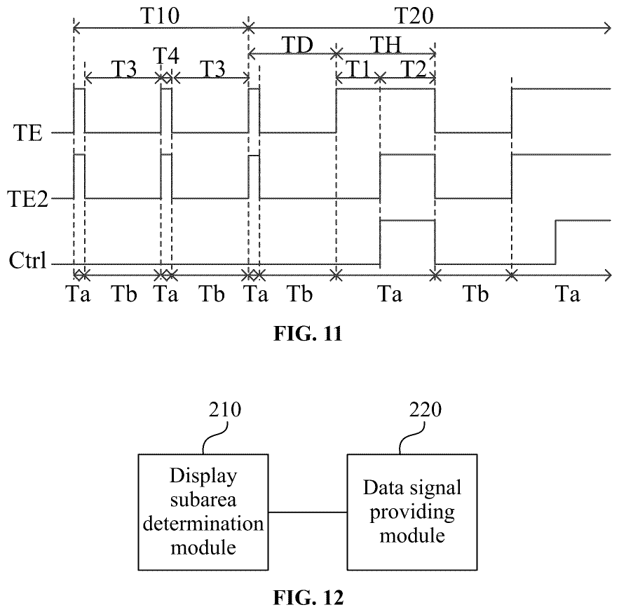

In an optional embodiment, FIG. 11 is a driving timing diagram of a display panel according to embodiments of the present disclosure. Referring to FIG. 5 and FIG. 10, outputting the first data output control signal according to the time when the grayscale data is acquired includes during a receiving period Tb of the grayscale data, outputting an effective level of the first data output control signal TE; and during a holding period Ta of the grayscale data, outputting an ineffective level of the first data output control signal TE.

By way of example, during the time period T10 in which data signals are written into different pixels 10 of the display panel 100 at a refresh rate of f₁, the period for the driver chip 30 to acquire grayscale data from the system mainboard may be 1/f₁ so that the first data output control signal TE changes periodically at a rate of 1/f₁. During the time interval between two acquisitions of grayscale data, the grayscale data acquired by the driver chip 30 remains unchanged, causing the first data output control signal TE to remain at an ineffective level. When the driver chip 30 begins to acquire grayscale data from the system mainboard, the grayscale data within the driver chip 30 starts to update, causing the first data output control signal TE to transition to an effective level.

During the time period T20 in which the pixels 10 in the first display area AA1 receive data signals at a refresh rate of f₁ while the pixels 10 in the second display area AA2 receive data signals at a refresh rate of f₂, the driver chip 30 may acquire grayscale data from the system mainboard at a period of 1/f₂. As a result, the first data output control signal TE may change periodically at a rate of 1/f₂. That is, during the time period TD in which the pixels 10 in both the first display area AA1 and the second display area AA2 are in a data write frame, the driver chip 30 acquires grayscale data from the system mainboard, causing the first data output control signal TE to transition to an effective level upon acquiring the grayscale data. In contrast, during the time period TH in which the pixels 10 in at least one of the first display area AA1 or the second display area AA2 are in a holding frame, the driver chip 30 stops acquiring grayscale data from the system mainboard, and the first data output control signal TE remains at an ineffective level.

Optionally, on the basis of the preceding embodiments, with continued reference to FIG. 5 and FIG. 11, outputting the second data output control signal TE2 according to the first data output control signal TE and the refresh control signal Ctrl includes when at least one of the first data output control signal TE or the refresh control signal Ctrl is at an effective level, outputting an effective level of the second data output control signal TE2; and when the first data output control signal TE and the refresh control signal Ctrl are each at an ineffective level, outputting an ineffective level of the second data output control signal TE2. When the second data output control signal TE2 is at the effective level, a data signal with a first preset driving strength is provided for the display panel 100; and when the second data output control signal TE2 is at an ineffective level, a data signal with a second preset driving strength is provided for the display panel 100. The first preset driving strength is greater than the second preset driving strength. In this manner, when at least one of the first data output control signal TE or the refresh control signal Ctrl is at an ineffective level, the second data output control signal TE2 generated by the driver chip 30 is at an ineffective level. At this time, the driving strength adjustment circuit 310 may control the data driving circuit 320 to output data signals with the second preset driving strength. Conversely, when both the first data output control signal TE and the refresh control signal Ctrl are at effective levels, the driving strength adjustment circuit 310 may control the data driving circuit 320 to output data signals with the first preset driving strength. This facilitates low power consumption of the display panel 100 and the driver chip 30 while satisfying the requirement for the pixels 10 in the display area with a higher refresh rate to be refreshed with data signals.

Optionally, with continued reference to FIG. 5 and FIG. 11, during part of the display period in the current driving mode, a data signal with the first preset driving strength is provided for each pixel 10 in the display panel.

The first preset driving strength may be a relatively large driving strength or may be a relatively small driving strength according to the actual display requirements of the display panel 100. This is not limited in this embodiment of the present disclosure.

Specifically, using an example in which the display panel in the current driving mode includes a first display area AA1 with a relatively high refresh rate and a second display area AA2 with a relatively low refresh rate, if part of the display period in the current driving mode is a time period in which both the pixels 10 in the first display area AA1 and the pixels 10 in the second display area AA2 are in a data write frame, then during this time period, the data signals provided by the data driving circuit 320 are required to be written one-to-one into different pixels 10. At this time, the driving strength adjustment circuit 310 may control the data driving circuit 320 to output, with the first preset driving strength, data signals for the pixels 10 in the first display area AA1 and to output, also with the first preset driving strength, data signals for the pixels 10 in the second display area AA2. That is, the data driving circuit 320 outputs data signals for all pixels 10 with a relatively large driving strength, thereby ensuring that both the first display area AA1 and the second display area AA2 can achieve fast charging. This allows the data write conditions of the display area AA1 with a higher refresh rate and the display area AA2 with a lower refresh rate to remain consistent, thereby improving the display uniformity of the display panel.

Alternatively, if part of the display period in the current driving mode is a time period in which both the pixels 10 in the first display area AA1 and the pixels 10 in the second display area AA2 are in a holding frame, then during this time period, it is not required to write the data signals provided by the data driving circuit 320 into different pixels 10. At this time, the driving strength adjustment circuit 310 may control the data driving circuit 320 to output, with the second preset driving strength, data signals for the pixels 10 in the first display area AA1 and to output, also with the second preset driving strength, data signals for the pixels 10 in the second display area AA2. That is, the data driving circuit 320 outputs data signals for all pixels 10 with a relatively small driving strength, thereby ensuring that the data driving circuit 320 can operate with lower power consumption and reducing the overall power consumption of the driver chip 30 and the display panel 100.

Optionally, on the basis of the preceding embodiments, with continued reference to FIG. 5 and FIG. 11, the display panel 100 includes multiple frame periods T3, the time period between two adjacent frame periods T3 is a blanking phase T4, and the driving method for the display panel also includes in the blanking phase T4, controlling the data driving circuit 320 to provide a data signal 10 with a third preset driving strength for each pixel in the display panel. The third preset driving strength is less than or equal to the second preset driving strength.

It is to be understood that the blanking phase T4 may be a vertical blanking phase, that is, a field blanking phase. The blanking phase refers to the time period from the end of the data write phase of the last row of pixels 10 in the display panel 100 to the beginning of the data write phase of the first row of pixels 10 in the display panel 100. This time period is between two adjacent frame periods T3. During the blanking phase, the image displayed on the display panel 100 can remain unchanged, and the data signals written into different pixels 10 in the display panel 100 can also remain unchanged, so that it is unnecessary to write the data signals provided by the data driving circuit 320 into different pixels 10 during this phase.

Specifically, since it is unnecessary to write data signals to different pixels 10 during the blanking phase, the data driving circuit 320 may be controlled by the driving strength adjustment circuit 310 to provide data signals with the third preset driving strength for different pixels 10. The third preset driving strength is less than or equal to the second preset driving strength. That is, when the driving strength value of the second preset driving strength is 0, the driving strength value of the third preset driving strength can also be 0; or when the driving strength value of the second preset driving strength is greater than 0, the driving strength value of the third preset driving strength can still remain 0, so that during the blanking phase T4, the data driving circuit 320 can output data signals with reduced driving strength, thereby reducing the power consumption of the data driving circuit 320 and the display panel 100.

Based on the same inventive concept, embodiments of the present disclosure provide a driving apparatus for a display panel. The driving apparatus for the display panel can reduce the power consumption of the display panel while ensuring a high display quality of the display panel. The driving apparatus for the display panel according to this embodiment of the present disclosure can perform the driving method for the display panel according to any embodiment of the present disclosure to control the display panel according to any embodiment of the present disclosure to display an image. The driving apparatus for the display panel can be implemented by software and/or hardware. The driving apparatus for the display panel can be integrated in a driver chip for driving the display panel. FIG. 12 is a block diagram illustrating the structure of a driving apparatus for a display panel according to embodiments of the present disclosure. As shown in FIG. 12, the driving apparatus for the display panel includes a display subarea determination module 210 and a data signal providing module 220.

The display subarea determination module 210 is configured to, when the current driving mode of the display panel is a multi-frequency driving mode, determine the refresh rate of each pixel in the display panel in the current driving mode, where the display panel in the current driving mode includes at least a first display area and a second display area, and the refresh rate of a pixel in the first display area is different from the refresh rate of a pixel in the second display area.

The data signal providing module 220 is configured to, during at least part of a display period in the current driving mode, control a data driving circuit to provide data signals with different driving strengths for the pixels in the first display area and the pixels in the second display area.

Optionally, the data signal providing module 220 is configured to provide a data signal with a first preset driving strength for the pixels in the first display area and provide a data signal with a second preset driving strength for the pixels in the second display area.

The refresh rate of the pixels in the first display area is greater than the refresh rate of the pixels in the second display area, and the second preset driving strength is less than the first preset driving strength.

Optionally, the driving strength value of the second preset driving strength is 0.

Optionally, the data signal providing module 220 is also configured to provide such data signals that the data signal provided for the pixels in the first display area is a data signal corresponding to the grayscale of the pixels in the first display area in the current display frame; and the data signal provided for the pixels in the second display area is a set data signal.

Optionally, the set data signal is the last data signal provided for a pixel in the display panel and corresponding to the grayscale of the pixel before the data signal with the second preset driving strength is provided for the pixels in the second display area.

Optionally, the voltage of the set data signal is a fixed value.

Optionally, the fixed value is the voltage of a data signal corresponding to a grayscale of 0.

Optionally, the display panel also includes a gate driving circuit, the gate driving circuit provides a gate driving signal for each row of pixels in the display panel, and the driving apparatus also includes a refresh control signal providing module.

The refresh control signal providing module is configured to, during the display period of one frame of the display panel, provide a refresh control signal for the gate driving circuit to control the gate driving signal provided for each row of pixels in the display panel by the gate driving circuit.

Optionally, the refresh control signal providing module is also configured to, when providing a data signal for each pixel in the first display area, provide an effective level of the refresh control signal for the gate driving circuit to control the gate driving circuit to sequentially provide an effective level of the gate driving signal for each row of pixels in the first display area; and when providing a data signal for each pixel in the second display area, provide an ineffective level of the refresh control signal for the gate driving circuit to control the gate driving circuit to sequentially provide an ineffective level of the gate driving signal for each row of pixels in the second display area.

Optionally, the driving apparatus also includes a second data output control signal determination module.

The second data output control signal determination module is configured to acquire grayscale data of the display panel in real time, where the grayscale data includes the grayscale of each pixel in the display panel; output a first data output control signal according to the time when the grayscale data is acquired; and output a second data output control signal according to the first data output control signal and the refresh control signal. The driving strength of a data signal provided for each pixel in the display panel is controlled according to the second data output control signal.

Optionally, the second data output control signal determination module is configured to, during the receiving period of the grayscale data, output an effective level of the first data output control signal; and during the holding period of the grayscale data, output an ineffective level of the first data output control signal.

Optionally, the second data output control signal determination module is also configured to, when at least one of the first data output control signal or the refresh control signal is at an effective level, output an effective level of the second data output control signal; and when the first data output control signal and the refresh control signal are each at an ineffective level, output an ineffective level of the second data output control signal.

When the second data output control signal is at the effective level, a data signal with a first preset driving strength is provided for the display panel; and when the second data output control signal is at an ineffective level, a data signal with a second preset driving strength is provided for the display panel. The first preset driving strength is greater than the second preset driving strength.

Optionally, during part of the display period in the current driving mode, a data signal with a first preset driving strength is provided for each pixel in the display panel.

Optionally, the display panel includes multiple frame periods, and a time period between two adjacent frame periods is a blanking phase.

The data signal providing module 220 is also configured to, in the blanking phase, control the data driving circuit to provide a data signal with a third preset driving strength for each pixel in the display panel. The third preset driving strength is less than or equal to the second preset driving strength.

The driving apparatus for the display panel according to this embodiment of the present disclosure can perform the driving method for the display panel according to any embodiment of the present disclosure. The driving apparatus for the display panel has the corresponding structure capable of performing the driving method for the display panel according to any embodiment of the present disclosure and can achieve the same beneficial effects as the driving method for the display panel according to any embodiment of the present disclosure. The same details can be understood with reference to the preceding description of the driving method for the display panel. The details are not repeated here.

Based on the same inventive concept, embodiments of the present disclosure provide a display device. The display device includes a display panel and a driver chip. The driver chip is configured to drive the display panel to display an image and perform the driving method for the display panel according to any embodiment of the present disclosure. Therefore, the driver chip has the corresponding structure capable of performing the driving method for the display panel according to any embodiment of the present disclosure and can achieve the same beneficial effects as the driving method for the display panel according to any embodiment of the present disclosure. The same details can be understood with reference to the preceding description of the driving method for the display panel. The details are not repeated here.

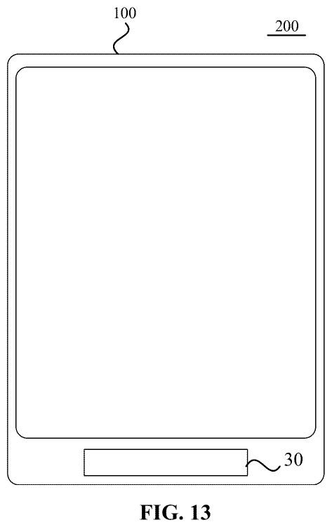

FIG. 13 is a diagram illustrating the structure of a display device according to embodiments of the present disclosure. As shown in FIG. 13, the display device 200 includes a display panel 100 and a driver chip 30. The driver chip 30 is configured to drive the display panel 100 to display. The display device 200 may include, but is not limited to, a mobile phone, a television, a laptop, a desktop display, a tablet computer, a digital camera, a smart bracelet, a smart glass, a vehicle-mounted display, medical equipment, industrial control equipment, and a touch interactive terminal. No special limitations are made thereto in embodiment of the present disclosure.

Based on the same inventive concept, an embodiment of the present disclosure also provides a computer-readable storage medium storing a computer instruction, where when executing the computer instruction, a processor performs the preceding driving method for the display panel provided in embodiment of the present disclosure.

In embodiment of the present disclosure, the computer-readable storage medium may be a tangible medium. The tangible medium may include or store the computer program used by or used in conjunction with an instruction execution system, apparatus, or device. The computer-readable storage medium may include but is not limited to an electronic, magnetic, optical, electromagnetic, infrared, or semiconductor system, apparatus, or device, or any appropriate combination thereof. Alternatively, the computer-readable storage medium may be a machine-readable signal medium. More specific examples of the machine-readable storage medium include an electrical connection having one or more wires, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage device, a magnetic storage device, or any appropriate combination thereof.

It is to be noted that the preceding are preferred embodiments of the present disclosure and technical principles used therein. It is to be understood by those skilled in the art that the present disclosure is not limited to the embodiments described herein. For those skilled in the art, various apparent modifications, adaptations, and substitutions can be made without departing from the scope of the present disclosure. Therefore, while the present disclosure is described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A driving method for a display panel, wherein the display panel comprises a plurality of pixels arranged in an array, and the driving method for the display panel comprises:
when a current driving mode of the display panel is a multi-frequency driving mode, determining a refresh rate of each pixel in the display panel in the current driving mode, wherein the display panel in the current driving mode comprises at least a first display area and a second display area, and a refresh rate of a pixel in the first display area is different from a refresh rate of a pixel in the second display area; and
during at least part of a display period in the current driving mode, controlling a data driving circuit to provide data signals with different driving strengths for the pixel in the first display area and the pixel in the second display area.

2. The driving method for the display panel according to claim 1, wherein controlling the data driving circuit to provide the data signals with different driving strengths for the pixel in the first display area and the pixel in the second display area comprises:
providing a data signal with a first preset driving strength for the pixel in the first display area and providing a data signal with a second preset driving strength for the pixel in the second display area;
wherein the refresh rate of the pixel in the first display area is greater than the refresh rate of the pixel in the second display area, and the second preset driving strength is less than the first preset driving strength.

3. The driving method for the display panel according to claim 2, wherein a driving strength value of the second preset driving strength is 0.

4. The driving method for the display panel according to claim 2, wherein
the data signal provided for the pixel in the first display area is a data signal corresponding to a grayscale of the pixel in the first display area in a current display frame; and
the data signal provided for the pixel in the second display area is a set data signal.

5. The driving method for the display panel according to claim 4, wherein the set data signal is a last data signal provided for a pixel in the display panel and corresponding to a grayscale of the pixel before the data signal with the second preset driving strength is provided for the pixel in the second display area.

6. The driving method for the display panel according to claim 4, wherein a voltage of the set data signal is a fixed value.

7. The driving method for the display panel according to claim 6, wherein the fixed value is a voltage of a data signal corresponding to a grayscale of 0.

8. The driving method for the display panel according to claim 1, wherein the display panel further comprises a gate driving circuit, the gate driving circuit provides a gate driving signal for each row of pixels in the display panel, and the driving method for the display panel further comprises:
during a display period of one frame of the display panel, providing a refresh control signal for the gate driving circuit to control the gate driving signal provided for each row of pixels in the display panel by the gate driving circuit.

9. The driving method for the display panel according to claim 8, wherein during the display period of the one frame of the display panel, providing the refresh control signal for the gate driving circuit to control the gate driving signal provided for each row of pixels in the display panel by the gate driving circuit comprises:
when providing a data signal for each pixel in the first display area, providing an effective level of the refresh control signal for the gate driving circuit to control the gate driving circuit to sequentially provide an effective level of the gate driving signal for each row of pixels in the first display area; and
when providing a data signal for each pixel in the second display area, providing an ineffective level of the refresh control signal for the gate driving circuit to control the gate driving circuit to sequentially provide an ineffective level of the gate driving signal for each row of pixels in the second display area.

10. The driving method for the display panel according to claim 8, further comprising:
acquiring grayscale data of the display panel in real time, wherein the grayscale data comprises a grayscale of each pixel in the display panel;
outputting a first data output control signal according to a time when the grayscale data is acquired; and
outputting a second data output control signal according to the first data output control signal and the refresh control signal;
wherein a driving strength of a data signal provided for each pixel in the display panel is controlled according to the second data output control signal.

11. The driving method for the display panel according to claim 10, wherein outputting the first data output control signal according to the time when the grayscale data is acquired comprises:
during a receiving period of the grayscale data, outputting an effective level of the first data output control signal; and during a holding period of the grayscale data, outputting an ineffective level of the first data output control signal.

12. The driving method for the display panel according to claim 10, wherein outputting the second data output control signal according to the first data output control signal and the refresh control signal comprises:
when at least one of the first data output control signal or the refresh control signal is at an effective level, outputting an effective level of the second data output control signal;
and when the first data output control signal and the refresh control signal are each at an ineffective level, outputting an ineffective level of the second data output control signal;
wherein when the second data output control signal is at the effective level, a data signal with a first preset driving strength is provided for the display panel; and when the second data output control signal is at an ineffective level, a data signal with a second preset driving strength is provided for the display panel; wherein the first preset driving strength is greater than the second preset driving strength.

13. The driving method for the display panel according to claim 1, further comprising:
during part of the display period in the current driving mode, providing a data signal with a first preset driving strength for each pixel in the display panel.

14. The driving method for the display panel according to claim 2, wherein the display panel comprises a plurality of frame periods, a time period between two adjacent frame periods of the plurality of frame periods is a blanking phase, and the driving method for the display panel further comprises:
in the blanking phase, controlling the data driving circuit to provide a data signal with a third preset driving strength for each pixel in the display panel;
wherein the third preset driving strength is less than or equal to the second preset driving strength.

15. A driving apparatus for a display panel, wherein the display panel comprises a plurality of pixels arranged in an array, and the driving apparatus for the display panel comprises a processor and a storage device, wherein the storage device stores processor-executable programs, and the programs comprise:
a display subarea determination module configured to, when a current driving mode of the display panel is a multi-frequency driving mode, determine a refresh rate of each pixel in the display panel in the current driving mode, wherein the display panel in the current driving mode comprises at least a first display area and a second display area, and a refresh rate of a pixel in the first display area is different from a refresh rate of a pixel in the second display area; and
a data signal providing module configured to, during at least part of a display period in the current driving mode, control a data driving circuit to provide data signals with different driving strengths for the pixel in the first display area and the pixel in the second display area.

16. A display device, comprising a display panel and a driver chip, wherein
the display panel comprises a plurality of pixels arranged in an array; and
the driver chip is configured to drive the display panel to display an image and perform:
when a current driving mode of the display panel is a multi-frequency driving mode, determining a refresh rate of each pixel in the display panel in the current driving mode,
wherein the display panel in the current driving mode comprises at least a first display area and a second display area, and a refresh rate of a pixel in the first display area is different from a refresh rate of a pixel in the second display area; and
during at least part of a display period in the current driving mode, controlling a data driving circuit to provide data signals with different driving strengths for the pixel in the first display area and the pixel in the second display area.

17. A non-transitory computer-readable storage medium storing a computer instruction which, when executed by a processor, causes the processor to perform the driving method for the display panel according to claim 1.
